(19) United States
(12) Patent Application Publication
(10) Pub. No.: US 2006/0214043 A1
(43) Pub. Date: Sep. 28, 2006

(54) Seat belt retractor and seat belt apparatus

(75) Inventor: Yasuaki Nomura, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/384,425

(22) Filed: Mar. 21, 2006

(30) Foreign Application Priority Data
Mar. 22, 2005 (JP) 2005-082105

(51) Int. Cl. B60R 22/36

(52) U.S. Cl. 242/374; 242/379.1

(57) ABSTRACT

The disclosed seat belt retractor may comprise an electric motor which can be disposed inside a cylindrical spool. The rotation of the electric motor may be transmitted to the spool via a sun gear, planetary gears and a carrier. In the event of an emergency, a locking mechanism may be actuated by the action of a deceleration sensor to lock the rotation of a locking base in the belt unwinding direction. However, the spool is about to continue to rotate in the belt unwinding direction due to the inertial movement of an occupant. Thus, an energy absorbing mechanism may be used to absorb the impact energy on the occupant and limiting the load on a seat belt 6 so that the load is not too large.

### BACKGROUND

The present invention relates to the technical field of a seat belt retractor, which is installed in a vehicle such as an automobile and which conducts the winding and unwinding of a seat belt by a motor for restraining and protecting an occupant, and a seat belt apparatus employing the same. More particularly, the present invention related to the technical field of a motor-driven type seat belt retractor having an energy absorbing mechanism (hereinafter, referred to as “EA mechanism”), which functions as a load limiting mechanism and which absorbs the impact energy applied to an occupant so as to limit the load on the seat belt in the event of an emergency such as a vehicle collision where a large deceleration, as compared to a normal deceleration, acts on the vehicle.

Vehicles such as automobiles have been equipped with seat belt apparatuses. In the event of an emergency such as a vehicle collision, where a large deceleration acts on the vehicle, the seat belt apparatus restrains an occupant with the seat belt so as to prevent the occupant from jumping out of the seat, thereby protecting the occupant. The seat belt apparatus is provided with a seat belt retractor, which winds up the seat belt in such a way that the seat belt can be unwound if needed.

Among such seat belt retractors, a seat belt retractor, which conducts the winding and unwinding of a seat belt by a motor, has been proposed. One example is disclosed in the PCT International Application Publication 2003-507252. The seat belt retractor disclosed in this document has an electric motor, which is disposed coaxially and in series with a belt reel on one side of the belt reel in the longitudinal direction. In this case, the rotation of the electric motor is reduced by a reduction mechanism composed of a planetary gear reduction mechanism and then transmitted to the belt reel. The belt reel is rotated in a belt winding direction or a belt unwinding direction by the rotation of the electric motor; whereby, the seat belt can be wound up onto and unwound from the belt reel. However, since the electric motor is disposed coaxially and in series with the belt reel on one side of the belt reel, the seat belt retractor in this case has a problem in that it has a large size in the longitudinal direction of the belt reel.

Another example of a seat belt retractor with a load limiting mechanism has been proposed in the Japanese Unexamined Patent Publication No. 2004-249968. In this case, the load limiting mechanism comprises an EA mechanism, which absorbs the impact energy acting on an occupant moving by inertial force when the seat belt is locked from being unwound in the event of an emergency such as a vehicle collision.

The applicant of the present disclosure has developed a seat belt retractor in which a spool (corresponding to the belt reel disclosed in PCT International Application Publication 2003-507252) for winding up the seat belt is formed in a cylindrical shape and a motor is disposed in a columnar space inside the spool coaxially with the spool so as to reduce the length of the spool in the longitudinal direction, thereby making the seat belt retractor more compact. The applicant has filed a patent application relating this seat belt retractor as disclosed in Japanese Patent Application No. 2004-349058.

However, the motor-driven type seat belt retractor of the Japanese Patent Application No. 2004-349058 has no EA mechanism capable of absorbing the impact energy acting on an occupant in the event of an emergency, such as the one as disclosed in the Japanese Unexamined Patent Publication No. 2004-249968. It is preferable to provide an EA mechanism to this motor-driven type seat belt retractor but it is difficult to simply add an EA mechanism.

The seat belt retractor of the present application was made under the aforementioned circumstances and an object of the present disclosure is to provide a motor-driven type seat belt retractor, which can be compact and capable of absorbing the impact energy on an occupant in the event of an emergency such as a vehicle collision.

Another object of the present application is to provide a seat belt apparatus which absorbs impact energy on an occupant when restraining the occupant by a seat belt in the event of an emergency such as a vehicle collision so that the occupant can be effectively restrained while being softly protected without receiving a large force from the seat belt.

### SUMMARY

In an embodiment of the seat belt retractor of the present application, the retractor may comprise a cylindrical spool that winds and unwinds a seat belt; a motor in which the motor shaft is disposed coaxially with the spool in a columnar space inside the spool and which generates a rotary driving force for rotating the spool in the belt winding direction and the belt unwinding direction; a reduction mechanism that is disposed between the spool and the motor to reduce and transmit the rotation of the motor; and an EA mechanism that absorbs the impact energy on an occupant when said spool rotates in the belt unwinding direction in the event of an emergency.

In addition, the seat belt retractor may further comprise a locking mechanism having a locking member, which rotates together with the spool in the normal state and being actuated in the event of an emergency. The locking member of the locking mechanism can be adapted to rotate freely in the normal state and can be locked from rotation in the belt unwinding direction in the event of an emergency. The EA mechanism may comprise a torsion bar disposed between the spool and the locking member. In a further embodiment, the seat belt retractor is characterized in that said torsion bar can be a motor shaft of said motor.

The locking member of the locking mechanism may be adapted to rotate freely in the normal state and can be locked from rotation in the belt unwinding direction in the event of an emergency. The energy absorbing mechanism may be composed of a torsion bar disposed between said spool and said locking member. The seat belt retractor may further comprise a second locking mechanism having a second locking member, which rotates together with said spool in the normal state and being actuated in the event of an emergency, and a second energy absorbing mechanism, which absorbs the impact energy on the occupant when the second locking mechanism is actuated and the spool rotates in the belt unwinding direction in the event of an emergency. The second locking member of the second locking mechanism can be adapted to rotate together with the spool and the second energy absorbing mechanism may be composed of a friction disc, which is adapted to rotate by friction. The second locking member is separated from the friction disc in the normal state and is rotationally connected to the friction disc in the event of an emergency.

A seat belt retractor in another embodiment is characterized in that the locking member of the locking mechanism is adapted to rotate together with the spool. The energy absorbing mechanism may be composed of a friction disc, which is adapted to rotate by friction. The locking member is separated from said friction disc in the normal state and is rotationally connected to the friction disc in the event of an emergency.

The friction disc may be structured to have a multiple disc structure composed of a plurality of discs.

The energy absorbing mechanism can be a control unit for driving said electric motor to rotate in the belt unwinding direction in the event of an emergency.

Another embodiment of the seat belt apparatus may comprise at least: a seat belt for restraining an occupant; a seat belt retractor for winding and unwinding said seat belt; a tongue slidably supported by said seat belt; and a buckle to which said tongue is detachably latched. The seat belt retractor may a seat belt retractor as disclosed herein.

In another embodiment of the seat belt retractor, the motor is coaxially disposed in a columnar space inside the cylindrical spool so that the seat belt retractor can be made compact in the longitudinal direction of the spool. The impact energy on the occupant is absorbed by the EA mechanism in the event of an emergency such as a vehicle collision, thereby limiting the force acting on the seat belt so that the force is not too large.

The EA mechanism may be composed of a torsion bar, thereby simplifying the structure of the energy absorbing mechanism. The torsion bar can be composed of the shaft of the motor, thereby reducing the number of components and further simplifying the structure of the EA mechanism. The absorption of the impact energy on the occupant may also be performed by the friction disc in addition to the absorption of impact energy on the occupant by the torsion bar, thereby further effectively absorbing the impact energy on the occupant.

The absorption of impact energy on the occupant may be performed by the friction disc, thereby increasing the degree of freedom of design about the rotational amount of the spool after the locking mechanism is actuated in the event of an emergency. Thus, the effect of absorbing the impact energy on the occupant can be variably set according to need.

Because the energy absorbing mechanism by the friction disc is provided only on one of the side walls of the base frame, the entire size of the seat belt retractor in the longitudinal direction is not so greatly increased even with the energy absorbing mechanism. Thus, the reduction in size of the seat belt retractor is effectively achieved. The EA mechanism in the form of the friction disc, the side wall for the same, the locking mechanism, and the deceleration sensor are combined into a unit, thereby facilitating the mounting of these components to the seat belt retractor. The friction disc may be structured to have a multiple disc structure, thereby further effectively absorbing the impact energy on the occupant without increasing the size of the seat belt retractor.

The impact energy on the occupant can be absorbed by the control unit driving the electric motor to rotate in the belt unwinding direction in the event of an emergency; whereby the impact energy on the occupant can be absorbed without any mechanical EA mechanism so that the load applied on the seat belt is limited without any mechanical load limiting mechanism. Therefore, the structure of the EA mechanism, i.e., the load limiting mechanism, can be effectively simplified; thus, a further reduction in size of the seat belt retractor can be achieved.

In the seat belt apparatus employing the seat belt retractor, the impact energy on the occupant can be absorbed by the energy absorbing mechanism when the occupant is restrained by the seat belt in the event of an emergency such as a vehicle collision, whereby the occupant can be effectively restrained while softly being protected without receiving a large force from the seat belt.

It is to be understood that both the foregoing general description and the following detailed description are exemplary and explanatory only, and are not restrictive of the invention as claimed.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is an illustration schematically showing an embodiment of a seat belt apparatus employing a seat belt retractor according to the present invention.

FIG. 2 is a vertical sectional view schematically showing an embodiment of the seat belt retractor according to the present invention.

FIG. 3(a) is a sectional view taken along a line A-A in FIG. 2, a line J-J in FIG. 8, and a line L-L in FIG. 9.

FIG. 3(b) is a sectional view taken along a line B-B in FIG. 2 and a line K-K in FIG. 8.

FIG. 4 is a sectional view showing another embodiment of the seat belt retractor of the present invention.

FIG. 5(a) is a sectional view taken along a line C-C in FIG. 4, a line E-E in FIG. 6, and a line G-G in FIG. 7.

FIG. 5(b) is a sectional view taken along a line D-D in FIG. 4, a line F-F in FIG. 6, and a line H-H in FIG. 7.

FIG. 6 is a sectional view showing another embodiment of the seat belt retractor of the present invention.

FIG. 7 is a sectional view showing another further embodiment of the seat belt retractor of the present invention.

FIG. 8 is a sectional view showing another further embodiment of the seat belt retractor of the present invention.

FIG. 9 is a sectional view showing another further embodiment of the seat belt retractor of the present invention.

### DETAILED DESCRIPTION

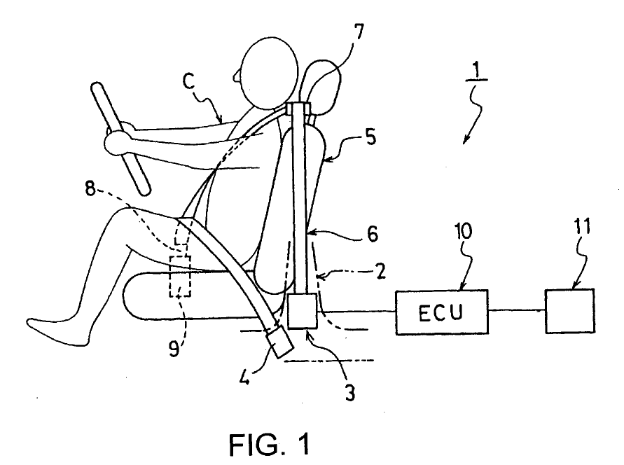

Embodiments of the present invention will now be described with reference to the drawings. As shown in FIG. 1, a seat belt apparatus 1 of this embodiment may comprise a seat belt retractor 3 which is fixed to a vehicle body such as a B-pillar 2 and is driven by a motor. A seat belt 6 can be unwound from the seat belt retractor 3 and is provided, at its end, with a belt anchor 4 which is fixed to a floor of the vehicle body or to a vehicle seat 5. A deflection fitting 7 can be fixed to a vehicle body, such as a center pillar, to guide the seat belt 6 unwound from the seat belt retractor 3 to a shoulder of an occupant C. A tongue 8 is slidably supported by the seat belt 6 guided from the deflection fitting 7. A buckle 9 may be fixed to the floor of the vehicle body or the vehicle seat and with which the tongue 8 is latched.

An electric control unit (ECU) 10 controls the motor of the seat belt retractor 3 while one or more input detectors 11 detects various information required for controlling the motor of the seat belt retractor 3. Such information may include information about collision prediction and collision occurrence of the vehicle to which the seat belt device 1 is mounted, information about the driving state of the vehicle, information about the sitting position and the body size of the occupant C seated in a vehicle seat 5, information about the traffic conditions around the vehicle, information about the weather conditions and time zones, information about the amount of winding or unwinding the seat belt 6, information about the latching of the tongue 8 with the buckle 9 from a buckle switch, and the like. Such information is inputted into the ECU 10 anytime or at predetermined intervals. The belt anchor 4, the seat belt 6, the deflection fitting 7, the tongue 8, and the buckle 9 may be conventionally known ones.

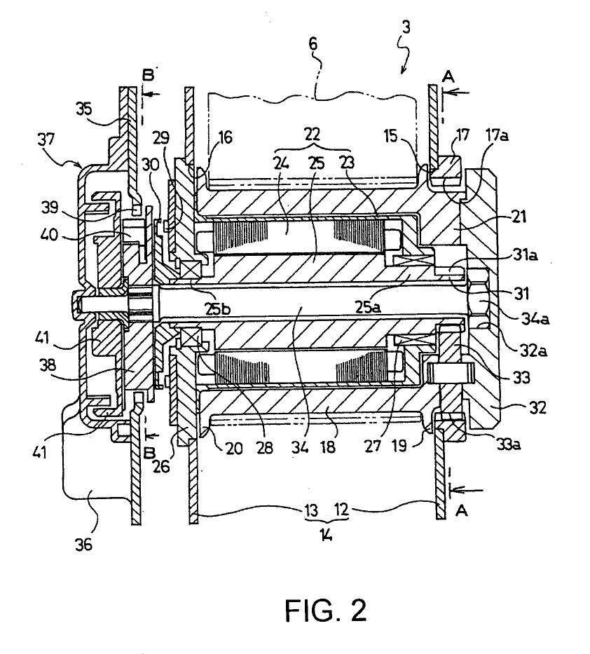

As shown in FIG. 2, a seat belt retractor 3 of this embodiment may comprise a base frame 14 having a pair of left and right side walls 12 and 13. The side walls 12 and 13 are provided with large circular openings 15 and 16 which are coaxially formed, respectively. Fitted in the opening 15 of one of the side walls 12 is an annular internal gear 17 having internal teeth 17a.

A spool 18 for winding the seat belt 6 such that the seat belt 6 can be unwound is disposed between the side walls 12 and 13. The spool 18 is provided with flanges 19, 20 at both of its ends for guiding the seat belt 6 when being wound. The spool 18 is formed in a cylindrical shape of which an end on the side wall 12 side has an annular end wall 21 having a center opening and the other end on the side wall 13 side is opened.

An electric motor 22 for generating a rotary driving force for rotating the spool 18 in the belt winding direction and the belt unwinding direction may be inserted through the open end of the spool at the side wall 13 side so that the electric motor 22 is accommodated in the spool 18. The electric motor 22 is a type of electric motor called a “brushless motor of an inner rotor type.” The motor may comprise a cylindrical motor housing 23, an annular stator 24 composed of a coil which is accommodated in and fixed to the motor housing 23, and a rotor 25 composed of a magnet which longitudinally extends through the motor housing 23 and the stator 24.

Most parts of the motor housing 23 can be accommodated in the spool 18. An end member 26 of the motor housing 23 on the side wall 13 side is composed of an annular disc and is fitted in the opening 16 of the side wall 13 so that the end member 26 is fixed to the side wall 13, whereby the motor housing 23 is fixed to the side wall 13. The stator 24 is positioned inside the motor housing 23 and is fixed to the motor housing 23. The rotor 25 is formed into a cylindrical shape and has both ends 25a, 25b which are rotatably supported by the motor housing 23 via a pair of bearings 27 and 28, respectively. Thus, the rotor 25 is structured to function as a motor shaft of the motor 22. The electric motor 22 is accommodated in the spool 18 such that the rotor 25, i.e. the motor shaft, is arranged coaxially with the spool 18.

A rotation sensor 29 composed of a hall element may be attached to the end member 26 of the motor housing 23 while a magnetic disc 30 is attached to the rotor 25 to face the rotation sensor 29 such that the magnetic disc 30 can rotate together with the rotor 25. The rotation sensor 29 and the magnetic disc 30 can compose an input detector for inputting the information about the amount of winding or unwinding of the seat belt 6 into the ECU 10 as one of the input detectors 11. The rotation sensor 29 and the magnetic disc 30 cooperate together to detect the rotational position of the rotor 25. From the information about the rotational position of the rotor 25, the amount of winding or unwinding of the seat belt 6 by the spool 18 can be obtained. That is, the rotation sensor 29 and the magnetic disc 30 as a position detector for detecting the rotational position of the rotor 25 are also used as a seat belt winding/unwinding amount detector for detecting the amount of winding or unwinding of the seat belt 6.

Based on the information about the rotational position of the rotor 25 detected by the rotation sensor 29 and the magnetic disc 30, i.e. based on the information about the amount of winding or unwinding of the seat belt 6, the ECU 10 controls the ON/OFF status of the electric motor 22, the rotation number of the electric motor 22, the rotational direction of the electric motor 22, the load of the electric motor 22, and the like. In this regard, the ECU 10 may actually control the power supply amount (specifically, the current value or the voltage value supplied to the coil) and the power supply direction (specifically, the direction of current supply to the coil) so as to perform the aforementioned various controls of the electric motor 22.

By using the brushless motor as the electric motor 22, the necessity of sensors for specially detecting the rotational position, the rotational speed, and the rotational direction of the rotor 25 is eliminated. Thus, the structure is simplified, thereby effectively reducing the size of the electric motor 22, improving the output of the electric motor 22, and improving the radiation property.

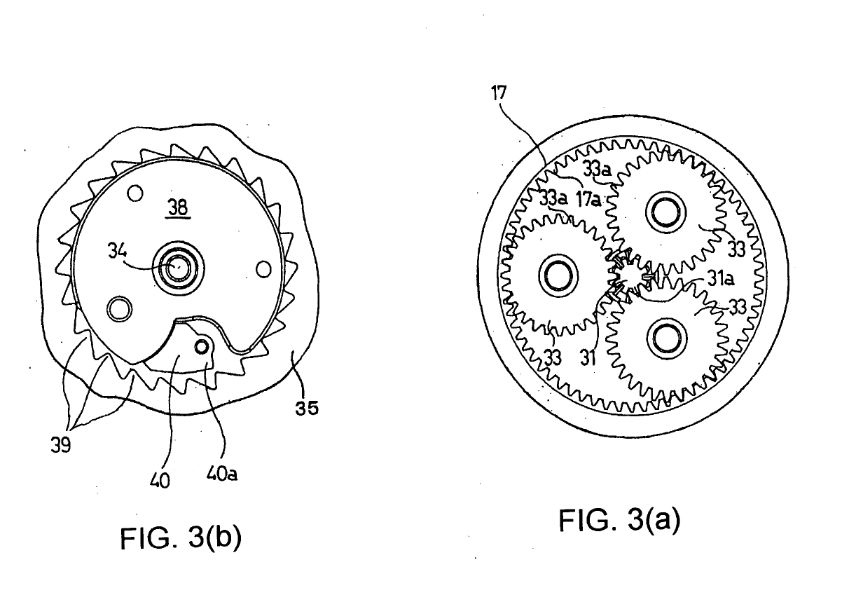

An annular sun gear 31 having external teeth 31a may be formed at an end portion 25a of the rotor 25 on the side wall 12 side such that the sun gear 31 can rotate together with the rotor 25. The external teeth 31a of the sun gear 31 are positioned to face the internal teeth 17a of the internal gear 17. The disc-like carrier 32 is connected and fixed to the end wall 21 of the spool 18 such that the carrier 32 can rotate together with the spool 18. Between the end wall 21 of the spool 18 and the carrier 32, planetary gears 33 each having external teeth 33a are rotatably disposed. As shown in FIG. 3(a), three planetary gears 33 can be arranged to be equally spaced from each other in the circumferential direction. The external teeth 33a of the each planetary gear 33 are always meshed with the external teeth 31a of the sun gear 31 and the internal teeth 17a of the internal gear 17. In this case, the internal gear 17, the sun gear 31, and the planetary gears 33 are aligned in the same plane perpendicular to the longitudinal direction (the left-right direction in FIG. 2), thereby achieving the reduction of length in the longitudinal direction.

With the aforementioned structure, the rotation of the rotor 25 of the electric motor 22 is reduced and transmitted to the spool 18 via the sun gear 31, the planetary gears 33, and the carrier 32 so that the spool 18 is rotated at a reduced speed by the rotation of the electric motor 22. The sun gear 31, the carrier 32, and the planetary gears 33 compose a planetary gear train reduction mechanism that can be the reduction mechanism.

A torsion bar 34 as an EA mechanism may be provided to extend through the cylindrical rotor 25. An end of the torsion bar 34 on the carrier 32 side is a head 34a having a hexagonal shape. The head 34a is fitted into a hexagonal concave portion 32a which is formed in the carrier 32 so that the head 34a is not allowed to rotate relative to the carrier 32.

A third side wall 35 can be arranged to be spaced apart from the side wall 13. Disposed on the third side wall 35 is a deceleration sensor 36, which is actuated by sensing a large deceleration of the vehicle that occurs in the event of an emergency, and a locking mechanism 37, which is actuated by the deceleration sensor 36 to lock at least the spool 18 from rotating in the belt unwinding direction. The deceleration sensor 36 and the locking mechanism 37 are conventionally well known as disclosed in, for example, Japanese Unexamined Patent Publication No. 2002-120694, herein incorporated by reference, and Japanese Unexamined Patent Publication No. 2001-122077, herein incorporated by reference. The structures and works of the deceleration sensor 36 and the locking mechanism 37 should be easily understood by reading these publications. Since these are not directly related to the present invention, concrete description of these is omitted, but a brief description will be made.

As shown in FIG. 2 and FIG. 3(b), the locking mechanism 37 comprises a locking base (corresponding to the “locking member” of the present disclosure) 38 disposed at the end that is opposite to the head 34a of the torsion bar 34. On the locking base 38, a pawl 40 having an engaging claw 40a which can engage one of annular internal teeth 39 formed in the third side wall 35 is rockably supported. The locking mechanism 37 also comprises a lock gear 41, which is attached to the torsion bar 34 adjacent to the locking base 38. When the deceleration sensor 36 is not actuated, the lock gear 41 can rotate together with the torsion bar 34, that is, the lock gear is not allowed to rotate relative to the locking base 38 and it keeps the pawl 40 at a position where it is impossible for the engaging claw 40a to engage the internal teeth 39. When the deceleration sensor 36 is actuated, the lock gear 41 is allowed to rotate relative to the torsion bar 34 and the locking base 38 and it moves the pawl 40 to a position where the engaging claw 40a can engage the internal teeth 39.

Therefore, in the normal state where the deceleration sensor 36 is not actuated, the locking base 38 and the lock gear 41 are allowed to freely rotate and rotate together with the torsion bar 34 and the spool 18. Conversely, in the event of an emergency where the deceleration sensor 36 is actuated, the rotation of the lock gear 41 is stopped, which generates a rotational difference between the lock gear 41 and the torsion bar 34 so as to move the pawl 40, whereby the engaging claw 40a engages one of the internal teeth 39 of the third side wall 35. Thus, the locking base 38 and the mounting portion of the torsion bar 34 to which the locking base 38 is attached are locked from rotation in the belt unwinding direction. Accordingly, the spool 18 is locked from an overly large rotation in the belt unwinding direction.

In the seat belt retractor 3 of this embodiment having the aforementioned structure, the locking mechanism 37 is not actuated so that the locking base 38 is allowed to freely rotate when the electric motor 22 is not driven to rotate. Therefore, the occupant can freely unwind the seat belt 6 from the spool 18 of the seat belt retractor 3.

As the occupant inserts and latches the tongue 8 to the buckle 9 after the occupant is seated in the vehicle seat 5 and unwinds a predetermined amount of the seat belt 6, the buckle switch as one of the input detectors 11 is actuated so as to input information about the latching of the tongue 8 to the buckle 9 into the ECU 10. Then, the ECU 10 drives the electric motor 22 to rotate in the belt winding direction. The rotation of the electric motor 22 is reduced and transmitted to the spool 18 through the planetary gear train reduction mechanism. Accordingly, the spool 18 rotates in the belt winding direction so that the excessively wound seat belt 6 is wound onto the spool 18, thereby removing the slack of the seat belt 6.

As the slack of the seat belt 6 is removed by the belt winding action, a further belt winding action produces belt tension on the seat belt 6 and increases the supply current or the supply voltage to the electric motor 22. At least one of the belt tension, the supply current and the supply voltage to the electric motor 22 during this action is detected by a suitable detector, which is used as one of the input detectors 11 and is inputted into the ECU 10. As at least one of the belt tension, the supply current, and the supply voltage that is inputted reaches a corresponding predetermined value, the ECU 10 stops the rotation of the electric motor 22. This state is maintained and the driving of the vehicle is started. After stopping the rotation of the electric motor 22, the ECU 10 may rotate the electric motor 22 slightly in the opposite direction, i.e. the belt unwinding direction. Thus, the spool 18 is rotated in the belt unwinding direction through the planetary gear train reduction mechanism to unwind a predetermined amount of the seat belt 6 so as to set the belt tension to be 0 or nearly 0, thereby placing the occupant in a comfortable state.

During the driving of the vehicle, the ECU 10 performs the aforementioned various controls of the electric motor 22 based on various information required for motor control, which are inputted from the input detectors 11 such that the belt tension is controlled to a suitable degree according to the various information provided.

As the vehicle is stopped and the occupant releases the tongue 8 from the buckle 9 for the purpose of exiting the vehicle, the buckle switch is placed in an inoperative state and information about the unlatching of the tongue 8 with the buckle 9 is inputted into the ECU 10. Then, the ECU 10 drives the electric motor 22 to rotate in the belt winding direction. By the rotation of the electric motor 22 in the belt winding direction, the spool 18 winds up the full amount of the seat belt 6, i.e. the unwound amount for wearing, until the seat belt 6 becomes to the initial fully wound state. Therefore, the seat belt 6 is accommodated in the seat belt retractor 3. As the seat belt 6 is fully wound, the ECU 10 stops the rotation of the electric motor 22 based on the information from the rotation sensor 29 and the magnetic disc 30 that the seat belt is fully wound.

In the event of an emergency such as a vehicle collision where a large deceleration acts on the vehicle during the driving of the vehicle, the deceleration sensor 36 is actuated so as to lock the rotation of the lock gear 41 in the belt unwinding direction, which rotates together with the rotation of the spool 18 in the belt unwinding direction because the seat belt 6 is about to be unwound by the inertial movement of the occupant. However, by further the inertial movement of the occupant, the locking base 38 is forced to continue the rotation in the belt unwinding direction so as to create a relative rotation between the lock gear 41 and the locking base 38. Because of the relative rotation, the lock gear 41 moves the pawl 40 on the locking base 38 toward the internal teeth 39 of the third side wall 35 so that the engaging claw 40a of the pawl 40 engages one of the internal teeth 39, thereby locking the locking base 38 from rotation in the belt unwinding direction. In other words, the mounting portion of the torsion bar 34 as the EA mechanism to which the locking base 38 is attached is locked from rotation in the belt unwinding direction so that the mounting portion of the torsion bar 34 to which the locking base 38 that is attached is prevented from rotating.

On the other hand, since the seat belt 6 is about to be unwound by further inertial movement of the occupant so that the spool 18 is about to continue the rotation in the belt unwinding direction, the head 34a of the torsion bar 34 is biased to rotate in the same direction via the carrier 32. Thus, the torsion bar 34 starts to be torsionally deformed. The torsional deformation of the torsion bar 34 absorbs the impact energy on the occupant, thereby limiting the load acting on the seat belt 6 so that it is not too large. In this manner, when an extremely large deceleration acts on the vehicle, the occupant can be restrained by the seat belt 6 without receiving a large force from the seat belt 6.

According to the seat belt retractor 3 of this embodiment, the electric motor 22 may be coaxially accommodated inside the cylindrical spool 18 so that the seat belt retractor 3 can be compactly formed in the longitudinal direction of the spool 18. Since the belt winding of the spool 18 is conducted by the rotary driving force of the electric motor 22, the necessity of a spring for winding up the seat belt which is conventionally provided in well known seat belt retractors can be eliminated, thereby further achieving reduction in size of the seat belt retractor 3 in the longitudinal direction.

Since the impact energy on the occupant is absorbed by the torsion bar 34 as the EA mechanism in the event of an emergency such as a vehicle collision, the load acting on the seat belt 6 is limited so as to not be too large. Since the EA mechanism is composed of the torsion bar 34, the structure of the EA mechanism can be simplified.

In addition, in the seat belt apparatus 1 employing the seat belt retractor 3, the impact energy on the occupant can be absorbed by the torsion bar 34 when the occupant is restrained by the seat belt 6 in the event of an emergency such as a vehicle collision. Therefore, the occupant can be effectively restrained while being softly protected without receiving a large force from the seat belt 6.

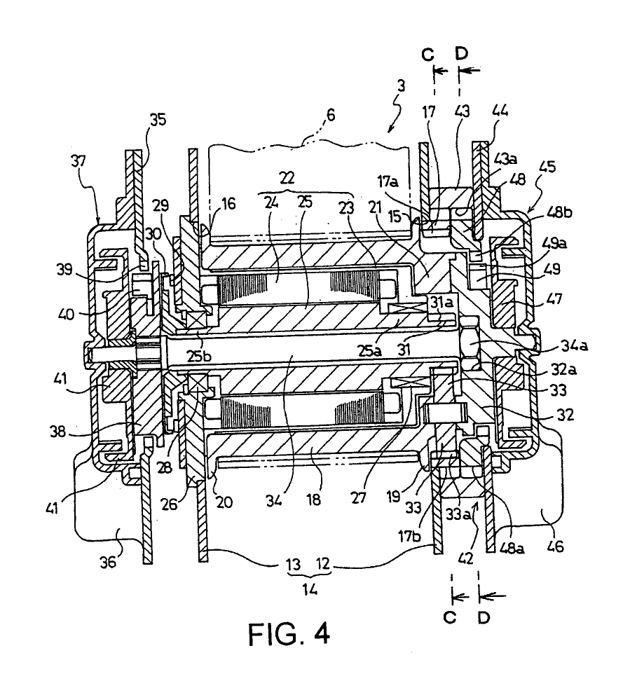

FIG. 4 is a sectional view similar to FIG. 2 showing another embodiment of the seat belt retractor of the present invention. In the following description, the same components as those of the aforementioned embodiment are marked with the same numerals so that the detailed description will be omitted.

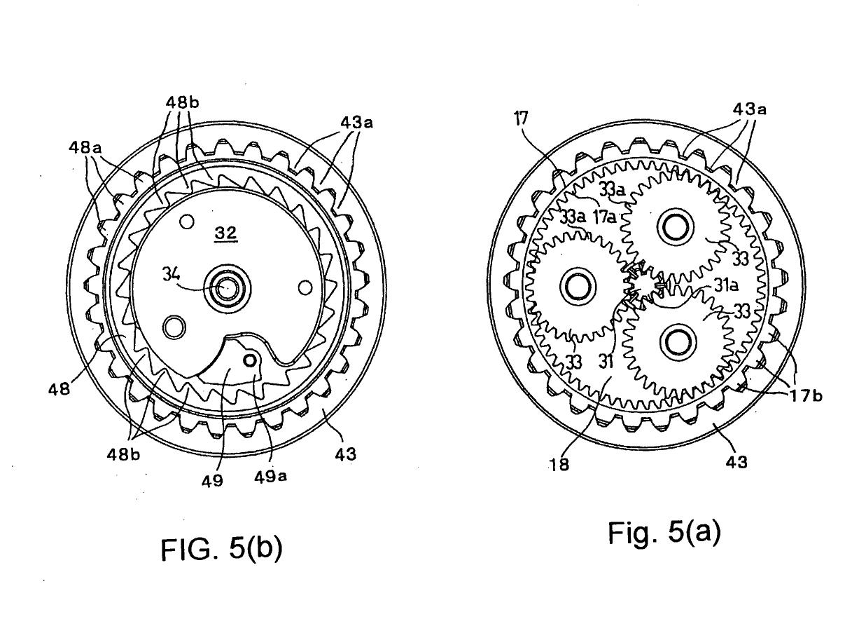

Though the torsion bar 34 is used as the EA mechanism in the aforementioned embodiment shown in FIG. 2, the seat belt retractor 3 is also provided with a second EA mechanism 42 in addition to the torsion bar 34, as shown in FIG. 4. The second EA mechanism 42 may comprise a single annular friction disc 43 having internal teeth 43a, as shown in FIG. 5(a). The friction disc 43 may be composed of a single friction material. The friction disc 43 is sandwiched and held between the side wall 12 and a fourth side wall 44 and generates a predetermined friction force relative to both the side walls 12 and 44. As a predetermined rotational force overcoming the friction force is applied to the friction disc 43, the friction disc 43 can slide relative to the side walls 12 and 44 against the friction force. Conversely, when a rotational force lower than the predetermined rotational force is applied to the friction disc 43, the friction disc 43 cannot slide relative to the side walls 12 and 44 against the friction force.

The internal gear 17 of this embodiment is fitted in the opening 15 of the side wall 12 in the circumferential direction such that the internal gear 17 can rotate relative to the side wall 12 and it has external teeth 17b formed around the outer periphery thereof. The external teeth 17b are always in mesh with the internal teeth 43a of the friction disc 43 so that the internal gear 17 and the friction disc 43 can rotate together with each other.

A second locking mechanism 45 and a second deceleration sensor 46 are both disposed on the fourth side wall 44. The second locking mechanism 45 may comprise a second lock gear 47, which is supported by the central shaft of the carrier 32 to allow relative rotation therebetween, and a ring gear 48 adjacent to the internal gear 17. The ring gear 48 has external teeth 48a and internal teeth 48b, as seen in FIG. 5(b). The external teeth 48a are always in mesh with the internal teeth 43a of the friction disc 43 so that the ring gear 48 and the friction disc 43 can rotate together with each other. On the carrier 32, a second pawl 49 having an engaging claw 49a, which is engageable with the internal teeth 48b of the ring gear 48, is rockably supported.

In the embodiment of FIG. 4, the second lock gear 47, the internal teeth 48b, the second pawl 49, and the second deceleration sensor 46 have the same structures and the same actions as the lock gear 41, the internal teeth 39, the pawl 40, and the deceleration sensor 36, respectively, but the former are arranged symmetrically with the latter. In this embodiment, the carrier 32 also functions as a locking base having the same function as the locking base 38 of the locking mechanism 37.

When the second deceleration sensor 46 is not actuated, the second lock gear 47 can rotate together with the carrier 32, i.e., the second lock gear 47 is not allowed to rotate relative to the carrier 32. Also, the second lock gear 47 keeps the second pawl 49 at a position where it is not possible for the engaging claw 49a to engage the internal teeth 48b. When the second deceleration sensor 46 is actuated, the second lock gear 47 is allowed to rotate relative to the carrier 32 and moves the second pawl 49 to a position where the engaging claw 49a thereof can engage the internal teeth 48b.

Therefore, in the normal state where the second deceleration sensor 46 is not actuated, the second lock gear 47 rotates together with the carrier 32 and the second pawl 49 is not actuated so that the engaging claw 49a thereof does not engage the internal teeth 48b of the ring gear 48. Accordingly, the carrier 32 and the friction disc 43 are separated.

On the other hand, in the event of an emergency where the second deceleration sensor 46 is actuated, the rotation of the second lock gear 47 is stopped, which generates a rotational difference between the second lock gear 47 and the carrier 32. Therefore, the second pawl 49 moves so that the engaging claw 49a thereof engages one of the internal teeth 48b of the ring gear 48. Thus, the carrier 32 and the friction disc 43 are rotationally connected via the ring gear 48 so that the rotational force of the carrier 32 is transmitted to the friction disc 43 via the ring gear 48 so as to bias the friction disc 43 to rotate.

Since the rotational force of the carrier 32 is large because it is now in the event of an emergency, the rotational force for biasing the friction disc 43 to rotate via the ring gear 48 becomes larger than the aforementioned predetermined rotational force. Thus, the friction disc 43 overcomes the friction force and slides relative to the side walls 12 and 44 against the friction force. By the frictional sliding of the friction disc 43, the impact energy on the occupant is absorbed, thereby limiting the force acting on the seat belt 6.

According to the seat belt retractor 3 of FIG. 4, the energy absorption by the torsional deformation of the torsion bar 34 and the energy absorption by the frictional sliding of the single friction disc 43 effectively absorb the impact energy on the occupant, thereby effectively limiting the load applied to the seat belt 6.

Since the friction disc 43 of the second EA mechanism 42 is provided only between the side wall 12 and the fourth side wall 44, the entire size in the longitudinal direction of the seat belt retractor 3 is not so greatly increased even with the addition of the second EA mechanism 42, thereby effectively achieving the reduction in size of the seat belt retractor 3.

The second EA mechanism 42 may be composed of the friction disc 43, the fourth side wall 44, the second locking mechanism 45, and the second deceleration sensor 46 that are combined into a unit, thereby facilitating the mounting of these components to the seat belt retractor 3.

Since the impact energy on the occupant is absorbed by the friction disc 43, the degree of freedom of design about the rotational amount of the spool 18 after the locking mechanism is actuated in the event of an emergency can be increased. The effect of absorbing the impact energy on the occupant can be variably set according to need.

The other structure, other works, and effects of the seat belt retractor 3 and the seat belt apparatus 1 of FIG. 4 are the same of those of the seat belt retractor 3 and the seat belt apparatus 1 of the aforementioned embodiment of FIG. 2.

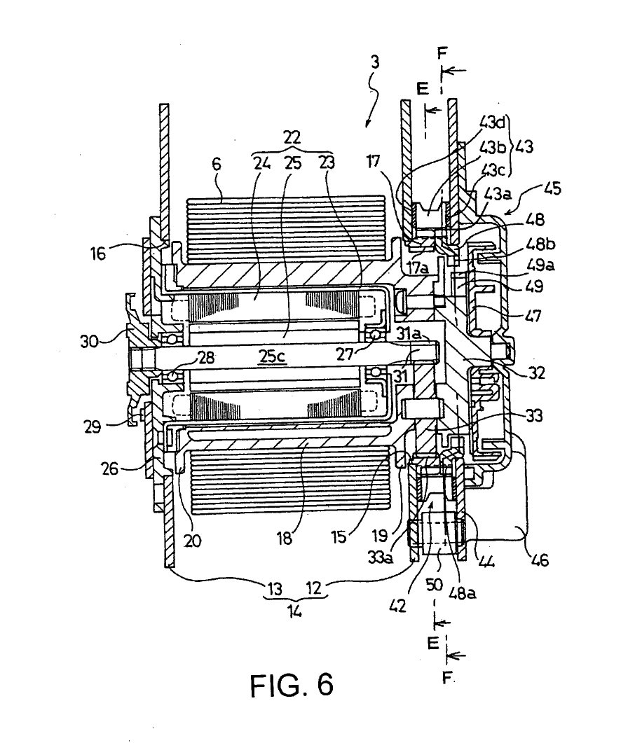

FIG. 6 is a sectional view similar to FIG. 2 but shows another further embodiment of the seat belt retractor of the present invention. Though the embodiment in FIG. 4 shows an EA mechanism comprising a torsion bar 34 and a second EA mechanism 42 composed of a single annular friction disc 43, a seat belt retractor 3 in FIG. 6 has no torsion bar 34 and comprises only the second EA mechanism 42.

That is, in the seat belt retractor 3 of this embodiment, the rotor 25 of the motor 22 is a motor shaft 25c and the torsion bar 34 extending through the rotor 25 in the embodiment shown in FIG. 4 is not provided. A sun gear 31 is formed at an end of the motor shaft 25c on the side wall 12 side such that the sun gear 31 rotates together with the motor shaft 25c. A magnetic disc 30 is attached to the other end of the motor shaft 25c on the side wall 13 side such that the magnetic disc 30 rotates together with the motor shaft 25c. The third side wall 35, the deceleration sensor 36, and the locking mechanism 37 of any of the embodiments shown in FIG. 2 and FIG. 4 are not provided in this embodiment of FIG. 6. Thus, the structure of the seat belt retractor 3 on the side wall 13 side is simplified.

In the embodiment of FIG. 6, the friction disc 43 comprises a ring-like friction disc supporting plate 43b and friction materials 43c, 43d which are formed into ring-like sheets and are bonded to both side surfaces of the friction disc supporting plate 43b. The friction disc supporting plate 43b is provided with internal teeth 43a.

Numeral 50 in FIG. 6 is a spacing member which defines the space between the side wall 12 and the fourth side wall 44 for setting the clamping force between the side walls 12 and 44 for clamping the friction disc 43 to a predetermined value, i.e., for setting the friction force between the friction disc 43 and the side walls 12, 44. The spacing member 50 may be a predetermined number of one or more members. The friction disc 43 may be composed of a single friction material as that of the embodiment shown in FIG. 4.

Even though the spacing member 50 is not shown in FIG. 4, the spacing member 50 may be provided in the embodiment shown in FIG. 4 as well. The friction disc 43 comprising the friction disc supporting plate 43b and the friction materials 43c, 43d may also be employed as the friction disc 43 of the embodiment shown in FIG. 4.

In the seat belt retractor 3 of FIG. 6, the impact energy on the occupant is absorbed by the energy absorption of the friction sliding of the single friction disc 43, thereby limiting the load applied to the seat belt 6.

Since there is no torsion bar 34 in this embodiment, the length of the seat belt retractor 3 in the longitudinal direction is shortened on the side wall 12 side. Since there is no third side wall 35, no deceleration sensor 36, and no locking mechanism 37, the length of the seat belt retractor 3 in the longitudinal direction is also shortened on the side wall 13 side, thereby achieving a more compact seat belt retractor 3.

The other structures, works, and effects of the seat belt retractor 3 and the seat belt apparatus 1 of FIG. 6 are the same of those of the seat belt retractor 3 and the seat belt apparatus 1 of any of the aforementioned embodiments.

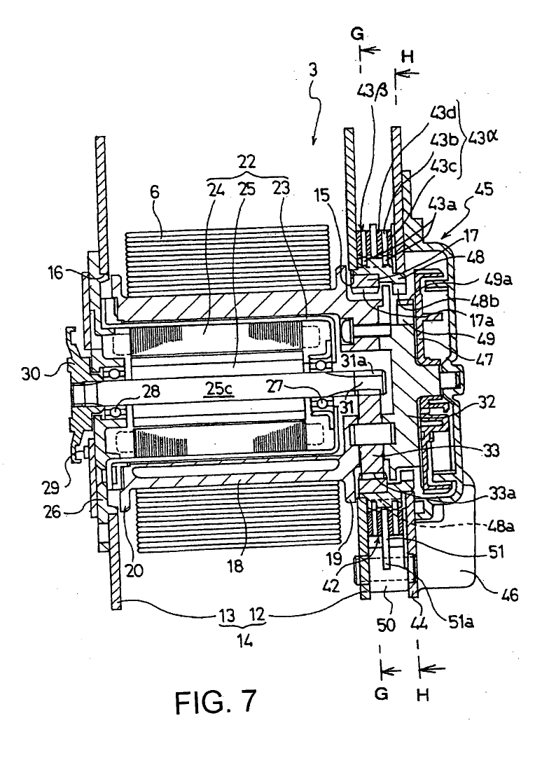

FIG. 7 is a sectional view similar to FIG. 2 but showing another further embodiment of the seat belt retractor of the present disclosure. The embodiment shown in FIG. 6 has the second EA mechanism 42 composed of a single annular friction disc 43. In contrast, FIG. 7 shows that the second EA mechanism 42 has a multiple disc structure composed of a plurality of annular friction discs 43 in a seat belt retractor 3. FIG. 7 shows two discs but three or more may be used.

In the seat belt retractor 3 of FIG. 7, a ring gear 48 is rotatably fitted to the opening 15 of the side wall 12 and an internal gear 17 is arranged inside the ring gear 48 such that there is no relative rotation between the internal gear 17 and the ring gear 48.

Between the side walls 12 and 44, two friction discs 43α, 43β may be disposed. These friction discs 43α, 43β each have the same structure as the friction disc 43 of the embodiment shown in FIG. 6 except for the thickness of the friction disc supporting plate 43b. In other words, each of the friction discs 43α, 43β may comprise a friction disc supporting plate 43b and friction materials 43c, 43d bonded to the friction disc supporting plate 43b. It should be understood that the friction discs 43α, 43β may also be a single friction disc as in the embodiment shown in FIG. 4.

The ring gear 48 has external teeth 48a formed around the outer periphery thereof. The internal teeth 43a of the two friction disc supporting plates 43b of the friction discs 43α, 43β are in mesh with the external teeth 48a of the ring gear 48. In this regard, the friction discs 43α, 43β are allowed to slide relative to the ring gear 48 in the longitudinal direction (the left-right direction in the drawing). Between the two friction discs 43α, 43β, a ring-like pressure receiving plate 51 is disposed. The pressure receiving plate 51 has a predetermined number of engaging portions 51a formed on the outer periphery thereof, which can engage a predetermined number of spacing members 50, respectively. Since these engaging portions 51a engage the corresponding spacing members 50, the pressure receiving plate 51 is not allowed to rotate and is allowed to slide relative to the spacing members 50 in the longitudinal direction (the left-right direction in the drawing).

The friction disc 43α is clamped between the side wall 44 and the pressure receiving plate 51 while the other friction disc 43β is clamped between the side wall 12 and the pressure receiving plate 51, whereby a predetermined friction force is set. Since the friction disc 43 is structured to have a multiple disc structure composed of the plates 43α, 43β in the aforementioned manner, a large friction force can be generated so that a great absorption of impact energy on the occupant can be achieved by the second EA mechanism 42.

In the seat belt retractor 3 of FIG. 7, the friction disc 43 is structured to have a multiple disc structure composed of the two friction discs 43α, 43β so that further efficient absorption of the impact energy on the occupant can be achieved without increasing the size of the seat belt retractor 3.

The other structures, works, and effects of the seat belt retractor 3 and the seat belt apparatus 1 of FIG. 7 are the same of those of the seat belt retractor 3 and the seat belt apparatus 1 of the aforementioned embodiment shown in FIG. 6.

It should be understood that the friction disc 43 of the embodiment shown in FIG. 4 may have a multiple disc structure similarly to this embodiment.

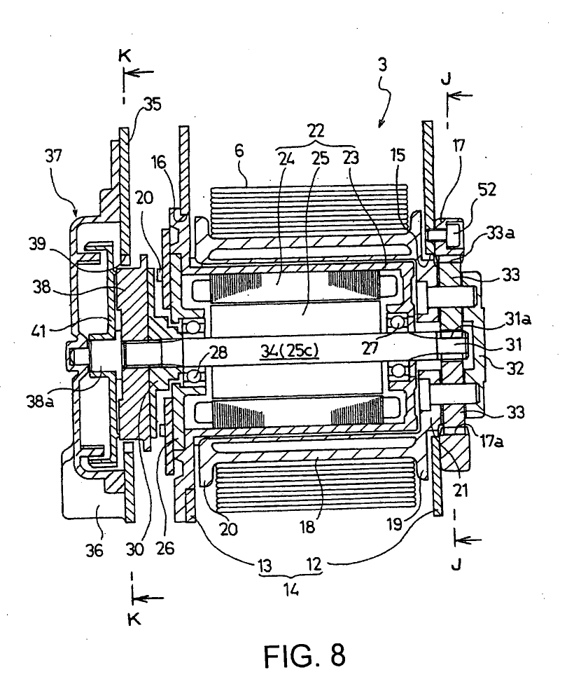

FIG. 8 is a sectional view similar to FIG. 2 but it shows another further embodiment of the seat belt retractor of the present disclosure. In the aforementioned embodiment shown in FIG. 2, the torsion bar 34 is provided to extend through the hollow rotor 25. In contrast, the embodiment of FIG. 8 has the rotor 25 of the motor 22 formed as a solid motor shaft 25c, similar to the embodiment shown in FIG. 6, in the seat belt retractor 3.

In the seat belt retractor 3 of FIG. 8, the motor shaft 25c is structured also as a torsion bar 34. In this regard, the torsion bar 34 has no head 34a. A sun gear 31 is formed at an end of the torsion bar 34 on the side wall 12 side, similarly to the embodiment shown in FIG. 6. An internal gear 17 is not fitted in the opening 15 of the side wall 12 but is attached to the surface around the opening 15 of the side wall 12 by one or more fasteners 52 such as bolts. Thus, the carrier 32 and the torsion bar 34 are rotationally connected to each other via the planetary gears 33 and the sun gear 31.

In the seat belt retractor 3 of this embodiment, a magnetic disc 30 is attached to the other end of the motor shaft 25c, i.e., the torsion bar 34, on the side wall 13 side such that the magnetic disc 30 can rotate together with the motor shaft 25c, similar to the embodiment shown in FIG. 6. In addition, a locking base 38 can be attached to the end of the torsion bar 34, i.e., the motor shaft 25c, on the side wall 13 side such that the locking base 38 can rotate together with the torsion bar 34. The locking base 38 has a central shaft 38a to which a lock gear 41 may be attached. In this regard, the lock gear 41 is attached to the central shaft 38a in such a manner that, in the normal state, the lock gear 41 can rotate together with the central shaft 38a and, in the event of an emergency, the rotation of the lock gear 41 is locked by the action of the deceleration sensor 36 and the central shaft 38a, i.e., locking base 38, can rotate relative to the lock gear 41 in a similar fashion to the aforementioned embodiments.

In the embodiment shown in FIG. 2, the carrier 32 directly rotates the head 34a of the torsion bar 34 during the locking operation of the locking mechanism 37 so as to torsionally deform the torsion bar 34, thereby conducting the EA operation by the torsion bar 34. In the embodiment of FIG. 8, however, the carrier 32 rotates the torsion bar 34 via the planetary gears 33 and the sun gear 31 during the locking operation of the locking mechanism 37 so as to torsionally deform the torsion bar 34, thereby conducting the EA operation by the torsion bar 34.

In the seat belt retractor 3 of FIG. 8, the torsion bar 34 may be composed of the motor shaft 25c of the electric motor 22, thereby reducing the number of components and further simplifying the structure of the EA mechanism.

The other structure, works, and effects of the seat belt retractor 3 and the seat belt apparatus 1 of FIG. 8 are the same of those of the seat belt retractor 3 and the seat belt apparatus 1 of the aforementioned embodiment shown in FIG. 2.

Also, in the seat belt retractor 3 of the embodiments shown in FIG. 6 and FIG. 7, the motor shaft 25c of the motor 22 may be structured as a torsion bar 34. It should be understood that, in this case, a locking mechanism 37 is required at the end of the motor shaft 25c on the side wall 13 side.

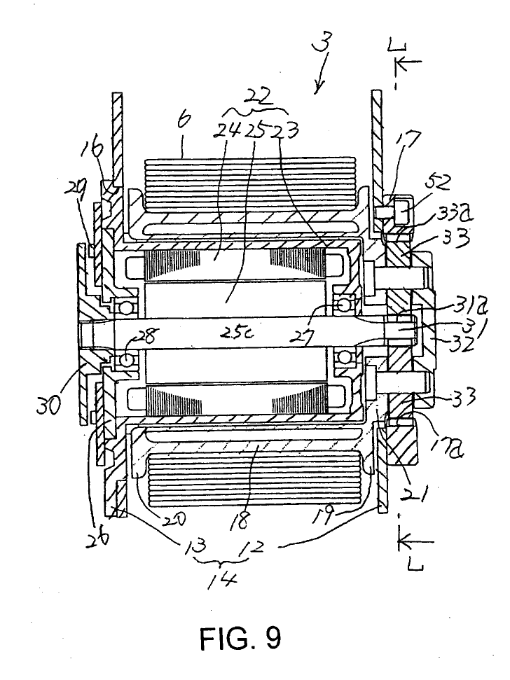

FIG. 9 is a sectional view similar to FIG. 2 but it shows another further embodiment of the seat belt retractor of the present invention. In the aforementioned embodiments of FIG. 2-8, the EA mechanism is a mechanical EA mechanism employing at least one of the torsion bar 34 and the friction disc 43 to mechanically absorb the impact energy on the occupant in the seat belt retractor 3. In the embodiment of FIG. 9, the seat belt retractor 3 has no mechanical EA mechanism composed of the torsion bar 34 and/or the friction disc 43. In other words, the third side wall 35, the deceleration sensor 36, and the locking mechanism 37 of the embodiment shown in FIG. 8 are not provided and the motor shaft 25c is not structured as a torsion bar 34. Thus, the seat belt retractor 3 of this embodiment has no mechanical EA mechanism.

The EA mechanism of the seat belt retractor 3 of FIG. 9 is composed of an ECU 10 and an input detector 11 as shown in FIG. 1. The ECU 10 is also structured as a control device, which controls the electric motor 22 to rotate in the belt unwinding direction at a predetermined rotation speed in the event of an emergency such as a vehicle collision. The input detector 11 includes an acceleration sensor (not shown), which detects the deceleration of the vehicle and outputs a detection signal to the ECU 10 as an electric signal.

In the seat belt retractor 3 of this embodiment having the aforementioned structure, when the ECU 10 determines, based on the deceleration of the vehicle detected by the acceleration sensor, that an extremely large deceleration as compared to normal deceleration of the vehicle is applied, the ECU 10 drives the electric motor 22 to rotate in the belt unwinding direction at a relatively low rotation speed. Then, the rotation of the electric motor 22 is reduced and transmitted to the spool 18 by the planetary gear reduction mechanism so that the spool 18 rotates slowly in the belt unwinding direction. At this point, the seat belt 6 is biased to be unwound by the inertial movement of occupant due to large deceleration. However, since the spool 18 rotates slowly in the belt unwinding direction, the load applied on the seat belt 6 is limited. Therefore, the impact energy on the occupant can be absorbed by the ECU 10 controlling the driving of the electric motor and the acceleration sensor is used as an input detector 11 without any mechanical EA mechanism.

In the seat belt retractor 3 of this embodiment, the impact energy on the occupant in the event of an emergency can be absorbed without any mechanical EA mechanism so that the load applied on the seat belt is limited without any mechanical load limiting mechanism, thereby effectively simplifying the structure of the EA mechanism (i.e. the load limiting mechanism) and achieving the further reduction in size of the seat belt retractor 3.

The other structure, works, and effects of the seat belt retractor 3 and the seat belt apparatus 1 of FIG. 9 are the same of those of the seat belt retractor 3 and the seat belt apparatus 1 of the aforementioned embodiment shown in FIG. 8.

Though the embodiment shown in FIG. 9 does not employ any mechanical EA mechanism, the EA action by at least one of the torsion bar 34 and the friction disc 43 may be added in addition to the EA action by the driving control of the electric motor 22. In this case, at least either a combination of the third side wall 35, the deceleration sensor 36, and locking mechanism 37 or a combination of the fourth side wall 44, the second deceleration sensor 46, and the second locking mechanism 45 of the aforementioned embodiments is required. This case can more effectively provide an EA effect.

Instead of the torsion bar 34 and the friction disc 43 as the mechanical EA mechanism, another mechanical EA mechanism, such as cutting, shearing, or breaking, as disclosed in the Japanese Unexamined Patent Publication No. 2004-249968, may be also employed.

The seat belt retractor of the present application is suitably adopted to a seat belt retractor which is installed in a vehicle such as an automobile and which conducts the winding and unwinding of a seat belt for restraining and protecting an occupant by a motor.

The priority application, Japanese Patent Application No. 2005-082105, filed march 22, 2005, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set for in the following claims.

What is claimed is:

1. A seat belt retractor comprising:
a cylindrical spool for winding and unwinding a seat belt;
a motor comprising a motor shaft disposed coaxially with the spool in a columnar space inside the spool, wherein the motor generates a rotary driving force for rotating the spool in a belt winding direction and a belt unwinding direction;
a reduction mechanism disposed between the spool and the motor for reducing and transmitting the rotation of the motor; and
a first energy absorbing mechanism for absorbing impact energy on an occupant when the spool rotates in the belt unwinding direction in an event of an emergency.

2. The belt retractor according to claim 1, wherein the first energy absorbing mechanism comprises a friction disc, and
wherein said friction disc is structured to have a plurality of disc structures.

3. A seat belt retractor as claimed in claim 1, wherein said first energy absorbing mechanism is a control unit for driving the motor to rotate in the belt unwinding direction in the event of an emergency.

4. The seat belt retractor according to claim 1, further comprising a first locking mechanism having a first locking member, wherein the first locking mechanism is configured to rotate together with the spool in a normal state and configured to be actuated in the event of an emergency.

5. The seat belt retractor according to claim 4, wherein the first locking member of the first locking mechanism is configured to rotate freely in the normal state and to be locked from rotation in the belt unwinding direction in the event of an emergency.

6. The belt retractor according to claim 4, wherein the first energy absorbing mechanism comprises a torsion bar disposed between the spool and the first locking member.

7. The belt retractor according to claim 6, wherein the torsion bar is a motor shaft of said motor.

8. The belt retractor according to claim 4, further comprising a second locking mechanism having a second locking member, wherein the second locking mechanism is configured to rotate together with the spool in the normal state and is configured to be actuated in the event of an emergency.

9. The belt retractor according to claim 8, further comprising a second energy absorbing mechanism for absorbing the impact energy on the occupant when the second locking mechanism is actuated and the spool rotates in the belt unwinding direction in the event of an emergency.

10. The belt retractor according to claim 9, wherein the second locking member of the second locking mechanism is configured to rotate together with the spool and the second energy absorbing mechanism, and
wherein the second energy absorbing mechanism comprises a friction disc.

11. The belt retractor according to claim 10, wherein the second locking member is configured to separate from said friction disc in the normal state and to be rotationally connected to the friction disc in the event of an emergency.

12. The belt retractor according to claim 4, wherein the energy absorbing mechanism comprises a friction disc, and
wherein the first locking member is configured to be separated from the friction disc in the normal state and to be rotationally connected to the friction disc in the event of an emergency.

13. A seat belt apparatus comprising at least:
a seat belt for restraining an occupant;
a seat belt retractor according to claim 1 for winding and unwinding said seat belt;
a tongue slidably supported by said seat belt; and
a buckle to which said tongue is configured to be detachably latched.

14. A seat belt retractor comprising:
a cylindrical spool for winding and unwinding a seat belt;
a motor comprising a motor shaft disposed coaxially with said spool in a columnar space inside the spool, wherein the motor generates a rotary driving force for rotating the spool in a belt winding direction and a belt unwinding direction;
a first energy absorbing mechanism for absorbing impact energy on an occupant when the spool rotates in the belt unwinding direction in an event of an emergency; and
a first locking mechanism having a first locking member, wherein the first locking mechanism is configured to rotate together with the spool in a normal state and configured to be actuated in the event of an emergency.

15. The belt retractor according to claim 14, further comprising a second energy absorbing mechanism for absorbing the impact energy on the occupant when the spool is rotated in the belt unwinding direction in the event of an emergency.

16. The belt retractor according to claim 15, wherein the first energy absorbing mechanism is a control unit for driving the motor to rotate in the belt unwinding direction in the event of an emergency and the second energy absorbing mechanism is selected from the group consisting of a friction disc and a torsion bar.
